(19) United States
(12) Patent Application Publication
(10) Pub. No.: US 2013/0045764 A1
(43) Pub. Date: Feb. 21, 2013

(54) ASSOCIATING A MEDICAL DEVICE WITH AN IDENTIFIER

(71) Applicants: Daniel VIK, La Jolla, CA (US); Sreelal CHANDRASENAN, San Diego, CA (US); Gregory BORGES, San Diego, CA (US); Donald HALBERT, San Diego, CA (US)

(72) Inventors: Daniel VIK, La Jolla, CA (US); Sreelal CHANDRASENAN, San Diego, CA (US); Gregory BORGES, San Diego, CA (US); Donald HALBERT, San Diego, CA (US)

(21) Appl. No.: 13/212,128

(22) Filed: Aug. 17, 2011

(51) Int. Cl. H04W 48/16

(52) U.S. Cl. 455/500

(57) ABSTRACT

A method for associating a medical device with an identifier. The method includes discovering a plurality of medical devices in a wireless network environment by an unassociated medical device, wherein each of the plurality of medical devices comprises an identifier; retrieving the identifiers of the plurality of medical devices; sorting the identifiers and the plurality of medical devices based on a proximity estimation between the plurality of medical devices and the unassociated medical device; and selecting an identifier of the identifiers to associate the unassociated medical device with the selected identifier.

### CROSS-REFERENCE TO RELATED U.S. APPLICATIONS

This application is related to U.S. patent application, Ser. No. ______, Attorney Docket Number CAFU-IRS110006US2, entitled, “MANAGING A PLURALITY OF ASSOCIATED MEDICAL DEVICES” by Vik, et al., with filing date ______, and assigned to the assignee of the present application.

### BACKGROUND

Typically, medical devices are manually associated to a patient. The manual association is time consuming and also provides an opportunity for incorrect information, such as mistyping, to be provided to the medical device.

Moreover, there is no interaction between multiple single or multi-channel systems assigned to the same patient. The systems are configured individually and there is no coordination of information between the systems.

### BRIEF DESCRIPTION OF THE DRAWINGS

FIG. 1 illustrates an example of a medical device, in accordance with an embodiment of the present invention.

FIGS. 2, 4 and 5 illustrate examples of a medical system environment, in accordance with embodiments of the present invention.

FIGS. 3, 6 and 7 illustrate examples of display information, in accordance with embodiments of the present invention.

FIG. 8 illustrates an example of a method for associating a medical device with an identifier, in accordance with an embodiment of the present invention.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

The following discussion will first describe the components of medical device 110. Then the discussion will describe the functionality of the components during use of medical device 110.

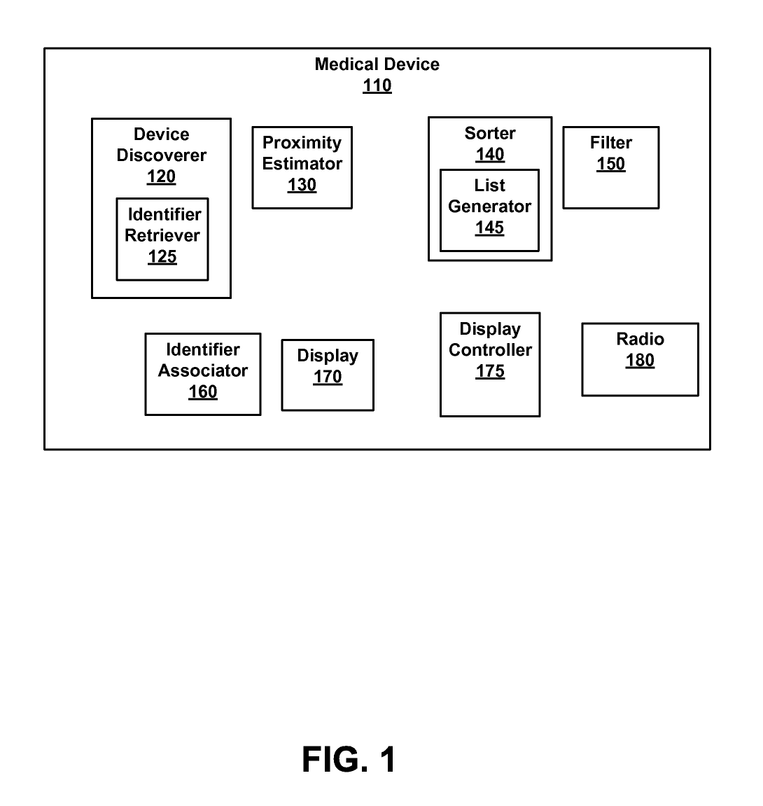

FIG. 1 depicts an embodiment of medical device 110. Medical device 110 is any medical device that is able to be associated with an identifier (e.g., patient identifier, patient area network identifier, etc).

Medical device 110 includes device discoverer 120, identifier retriever 125, proximity estimator 130, sorter 140, list generator 145, filter 150, identifier associator 160, display 170, display controller 175 and radio 180.

Device discoverer 120 is for discovering medical devices in a wireless network environment. Device discoverer 120 includes identifier retriever 125.

Identifier retriever 125 is for retrieving a variety of information associated with the discovered medical devices. For example, identifiers of the discovered medical devices in the wireless network environment, information for displaying/sorting device discrimination, device type, manufacturer, patient ID association, patient room, etc. It should be understood that any information retrieved by identifier retriever 125 is an identifier.

Proximity estimator 130 is for estimating the proximity between medical device 110 and other medical devices that are discovered by device discoverer 120.

Sorter 140 is for sorting the discovered medical devices and/or their respective identifiers. In one embodiment, sorter 140 sorts the discovered medical devices and/or their respective identifiers based on the proximity between medical device 110 and the discovered medical devices. For example, sorter 140 sorts the discovered medical devices and/or their respective identifiers into a list or table. In such an example, the discovered medical devices in the same room are sorted into a list or table.

Filter 150 is for filtering out one or more of an identifier and a discovered medical device. In one embodiment, filter 150 is for filtering out one or more of a subset of the identifiers and a subset of the discovered medical devices.

Identifier associator 160 for associating medical device 110 with an identifier. In one embodiment, identifier associator 160 automatically associates medical device 110 with an identifier. In another embodiment, identifier associator 160 associates medical device 110 in response to a user selected identifier.

Display 170 is for displaying information associated with functional aspects of medical device 110 to a clinician. Display 170 can be any display that is able to display appropriate device and/or patient related information to a clinician.

Display controller 175 is for controlling display 170. In particular, display controller 175 is for controlling the viewing functionalities of the information displayed on display 170. For example, controlling the backlighting and/or contrast, and lists for user selection.

Radio 180 is for communicating with other medical devices. In one embodiment, radio 180 is a short range radio utilizing protocols, such as, but not limited to, Bluetooth, ZigBee, 802.11, RFID tags, etc.

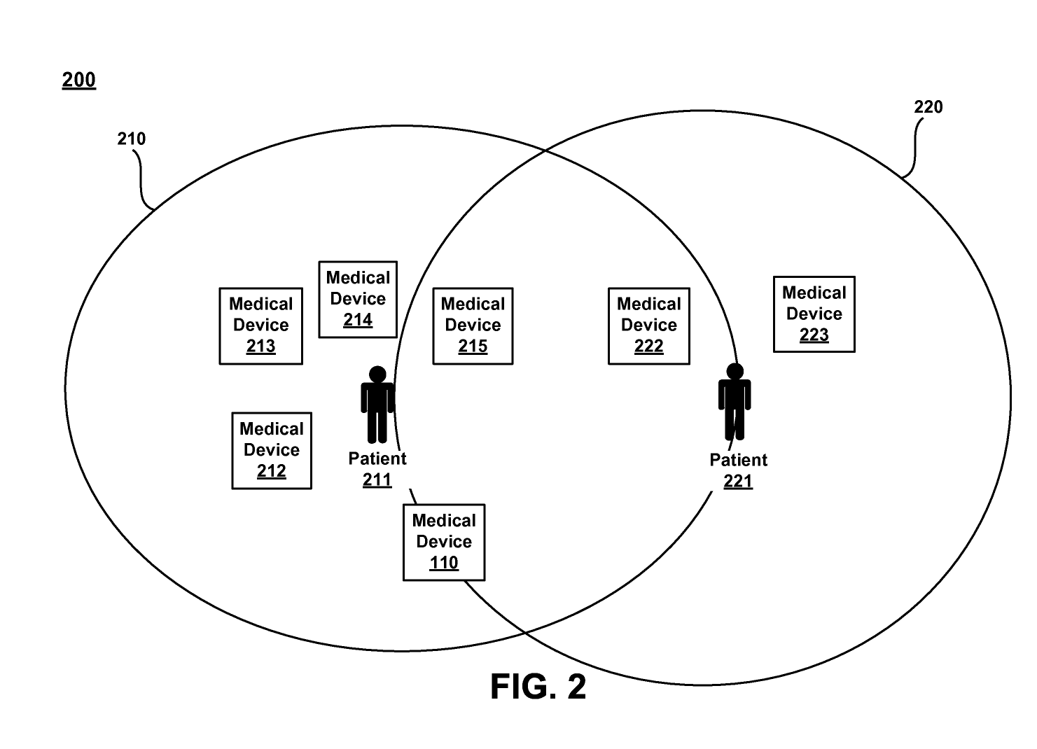

FIG. 2 illustrates an example of a medical system environment 200 (e.g., a wireless network environment). Medical system environment 200 includes a first patient area network that includes medical devices 212-215 that are associated with patient 211, and a second patient area network that includes medical devices 222 and 223 associated with patient 221. Accordingly, medical devices 212-215 are assigned to exclusively deliver care to patient 211, and medical devices 222 and 223 are assigned exclusively to deliver care to patient 221.

Medical devices 212-215 associated with patient 211 can be in close proximity to patient 211, for example, in the same room and next to the bed of patient 211. However, medical devices 212-215 can be in other areas that are not in the same room or next to the bed of patient 211. For example, one or all of medical devices 212-215 can be in another room or another part of the hospital.

Moreover, FIG. 2 depicts medical devices 212-215 associated with patient 211. However, it should be appreciated than any number of medical devices operating alone and/or in combination can be associated with patient 211.

Medical devices 222 and 223 associated with patient 221 can be in close proximity to patient 221, for example, in the same room and next to the bed of patient 221. However, medical devices 222 and 223 can be in other areas that are not in the same room or next to the bed of patient 221. For example, one or all of medical devices 222 and 223 can be in another room or another part of the hospital.

Moreover, FIG. 2 depicts medical devices 222 and 223 associated with patient 221. However, it should be appreciated than any number of medical devices operating alone and/or in combination can be associated with patient 211.

Medical devices 212-215, 222 and 223 can be any medical device for the care and/or monitoring of patients. Medical devices 212-215, 222 and 223 can be, but are not limited to, respirators, vital sign monitors, medication delivery systems, etc.

Medical devices 212-215, 222 and 223 include wireless connectivity to enable data sharing between the devices. Each medical device is configured with information, such as a patient identification or name. Other information can include, but is not limited to, device type or class, universal identifier, manufacturer, association capabilities and configurations and the like. As such, the information (e.g., patient identifier) can be shared with other devices within connectivity reach. Moreover, the information provides a logical grouping for the medical devices associated to the respective patient.

The wireless connectivity can occur due to a short range radio to allow the medical devices to discover and communicate with other devices that are located within a short distance. Accordingly, medical device 110 is able to discover and communicate with the medical devices, which will be described in detail below.

Referring to FIGS. 1 and 2, medical device 110 is a medical device that is not initially associated with patient 211 for the support and care of patient 211. It is a goal for medical device 110 to be associated with the first patient area network that includes medical devices 212-215 and not be associated with medical devices 222 and 223 that are associated with patient 221. Medical devices 212-215 in the first patient area network have a connectivity reach depicted by area 210. Similarly, medical devices 222 and 223 have a connectivity reach depicted by the area 220.

To initiate being associated with patient 211, medical device 110 utilizes device discoverer 120 to discover all of the devices within proximity to patient 211. Additionally, identifier retriever 125 retrieves the identifiers of the discovered medical devices.

In one embodiment, device discoverer 120 of medical device 110 discovers medical devices 212-215, 222 and 223. In particular, medical device 110 scans the devices within area 210 via radio 180 and device discoverer 120 subsequently discovers medical devices 212-215, 222 and 223.

Moreover, identifier receiver 125 receives the identifiers of each discovered medical device. For example, identifier receiver 125 receives an identifier (e.g., patient ID of patient 211) associated with medical devices 212-215 and an identifier (e.g., patient ID of patient 221) associated with medical devices 222 and 223.

Proximity estimator 130 estimates the proximity of discovered medical devices 212-215, 222 and 223 based on proximity measurements. In one embodiment, proximity estimator 130 estimates the proximity of discovered medical devices 212-215, 222 and 223 based on signal strength between medical device 110 and medical devices 212-215, 222 and 223. In such an embodiment, the medical devices that are closer to medical device 110 have a stronger signal.

For example, radio 180 is a radio and proximity estimator 130 estimates the proximity based on the signal strength between medical device 110 and discovered medical devices 212-215, 222 and 223. As such, the signal strength between medical device 212 is stronger than the signal strength of medical device 222, because medical device 212 is closer to medical device 110 than medical device 222.

Medical device 110 is able to determine or estimate proximity with discovered medical devices in a variety of ways. For instance, medical device 110 utilizes locating means such as, but not limited to, asset location, room based location (e.g., via RFID), local wired or wireless networks and global position system (GPS).

Sorter 140 sorts the discovered medical devices and respective identifiers before the information is presented to the clinician via display 170. In one embodiment, sorter 140 sorts the identifiers and discovered medical devices 212-215, 222 and 223 based on proximity (or other criteria) between medical devices 212-215, 222 and 223 and medical device 110 (which is still unassociated with patient 211).

In another embodiment, sorter 140 sorts the discovered medical devices 212-215, 222 and 223 and their respective identifiers based signal strength. Accordingly, list generator 145 generates a sorted list, such that medical devices (or device clusters) having a high signal strength are viewed before medical devices (or device clusters) with a lower signal strength. Moreover, patient identifiers retrieved from medical devices close to the medical device 110 can be displayed on top of the list. Additionally, the list can be further truncated so that patients located further way than a configured threshold are removed from the list and not displayed to the clinician.

In a further embodiment, sorter 140 utilizes the means of connectivity to facilitate in sorting. For example, list generator 145 generates a sorted list, such that medical devices utilizing short range radios are viewed before medical devices utilizing other connectivity means.

In various embodiments, sorter 140 is configured to sort discovered medical devices based on various information (e.g., any information collected during discovery, device classes and type, room number, asset location, clinical state, etc.). Moreover, additional information (e.g., care area) may be presented to a user to facilitate in sorting.

Table 1 below depicts an embodiment of a list or table generated by list generator 145.

| Device | Identifier | Proximity Estimate |
|---|---|---|
| Medical Device 214 | Patient 211 | 35 |
| Medical Device 215 | Patient 211 | 40 |
| Medical Device 222 | Patient 221 | 30 |
| Medical Device 213 | Patient 211 | 30 |
| Medical Device 223 | Patient 221 | 20 |
| Medical Device 212 | Patient 211 | 35 |

Filter 150 filters out one or more of identifiers and discovered medical devices. In particular, filter 150 narrows down the list based on other characteristics, such as care area, room number, device type (e.g., clusters that include infusion devices), manufacturer, patient associations, clinician associations, devices that can be connected to other infusion systems, etc.

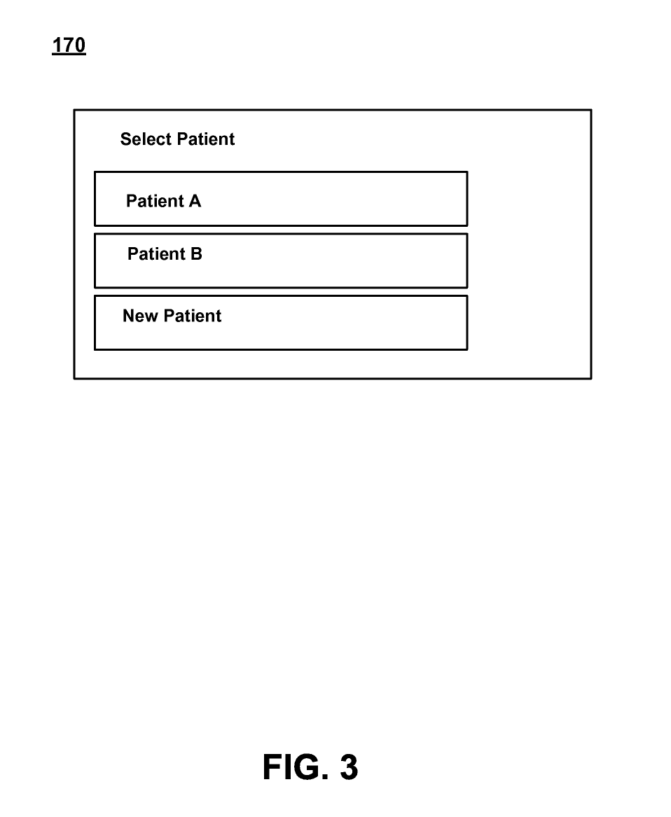

FIG. 3 depicts an embodiment of a list of information displayed to a clinician on display 170. As the list of patients can be based on distance to the medical device, the clinician is presented with a manageable number of possible patients to which a new medical device may be associated.

According to the information described in Table 1, “Patient A” (e.g., patient 211) is displayed ahead of or before “Patient B” (e.g., patient 221). Accordingly, a clinician would select the identifier “Patient A,” such that medical device 110 is associated with the identifier for patient 211.

In response to the selection of “Patient A,” identifier associator 160 associates medical device with the identifier for patient 211. Therefore, medical device 110 is associated with medical devices 212-215 and is not associated with medical devices 222 and 223 that are associated with patient 221.

In one embodiment, display 170 includes an option to manually create an association identifier. The manual creation can be facilitated by human interface devices (HID), such as a keyboard, touchscreen, knob, etc. In one example, inputs, such as bar code, can be enabled when the screen showing the patient ids allows the clinician to use the bar code without explicitly pressing a button.

In the case where medical device 110 is already configured with a patient identifier, medical device 110 may be automatically associated with a patient area network without displaying a “Select Patient” dialog, as depicted in FIG. 3.

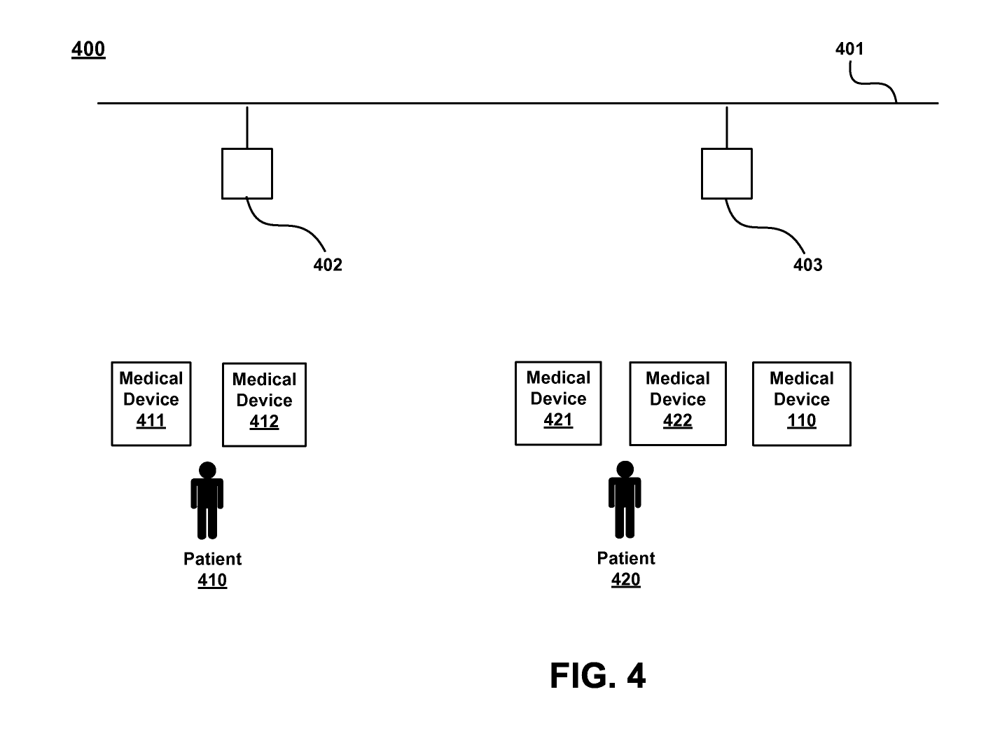

FIG. 4 depicts an embodiment of a medical system environment 400 that utilizes GPS to determine the proximity between medical device 110 and medical devices 411, 412, 421 and 422 and then share the information over LAN 401.

Each medical device includes a GPS (not shown). Each medical device communicates its location via a GPS to wireless access points 402 and/or 403.

To initiate being associated with patient 420, medical device 110 utilizes device discoverer 120 to discover all of the devices within proximity to medical device 110 via LAN 401. Additionally, identifier retriever 125 retrieves the identifiers of the discovered medical devices.

Medical device 110 then creates a list of patient identifiers based on the results from the discovery, removes devices that are not located in the near proximity to medical device 110 and then presents the list of remaining patient identifiers to the clinician in the same fashion as described above. For example, patient 420 is displayed at the top of a list based on the proximity of devices associated with patient 420.

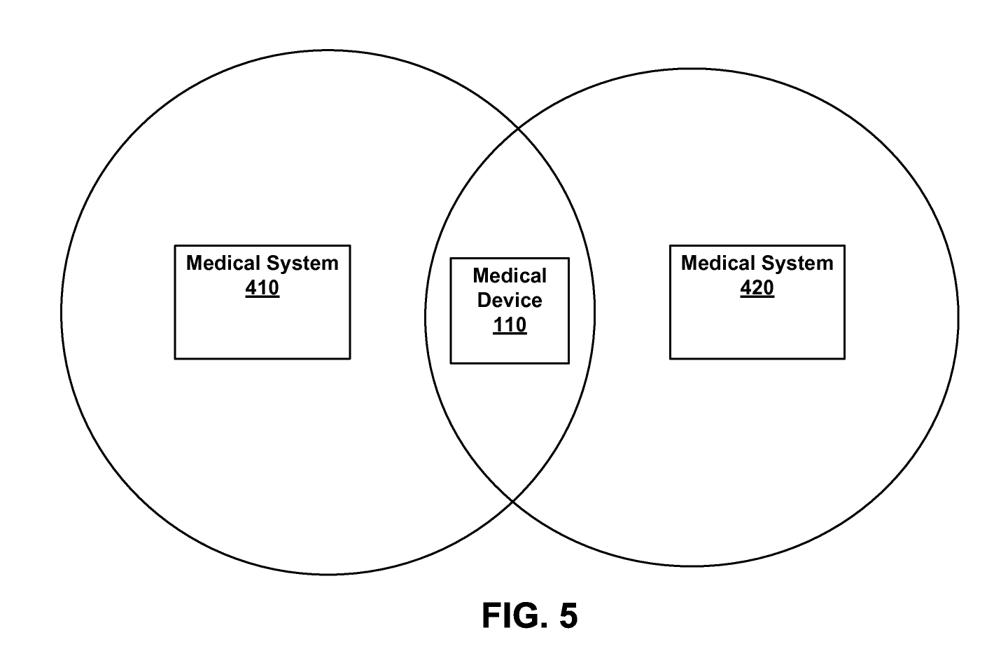

FIG. 5 illustrates an example of a medical system environment 500. Medical system environment 500 includes medical systems 511 and 521. Medical system 511 is closely coupled cluster of medical devices, such as, wirelessly equipped infusion pumps. Similarly, medical system 521 is a closely coupled cluster of medical devices, such as, wirelessly equipped infusion pumps.

Medical systems 511 and 521 each have a unique identifier. As such, each medical device of medical system 511 has the same unique identifier. Likewise, each medical device of medical system 521 has the same unique identifier.

Medical devices in medical system 511 have a connectivity reach depicted by area 510. Similarly, medical devices in medical system 521 have a connectivity reach depicted by the area 520.

In various embodiments, medical systems 511 and 521 include medical devices with specific functions. For example, medical systems 511 and 521 each include a plurality of devices such, but not limited to, wirelessly equipped stand alone infusion channels forming a multi-channel infusion system. In such an example, medical systems 511 and 521 each include a plurality of syringe devices, LVP devices, control units, etc.

Medical device 110 is a medical device to be associated with medical system 511. For example, medical device 110 is an additional LVP device for use by medical system 511.

Accordingly, medical device 110 utilizes device discoverer 120 to discover all of the devices within proximity. Additionally, identifier retriever 125 retrieves the identifiers of the discovered medical devices.

Medical device 110 then creates a list of identifiers based on the results from the discovery, removes devices and/or systems that are not located in the near proximity to medical device 110 and then presents the list of remaining identifiers to the clinician in the same fashion as described above.

Table 2 below depicts an embodiment of a list or table generated by list generator 145 with respect to medical system environment 500.

| Device | Identifier | Proximity Estimate |
|---|---|---|
| Syringe Device 1 | Infusion System A | 45 |
| LVP Device 1 | Infusion System A | 40 |
| Optional Control Unit 1 | Infusion System A | 35 |
| LVP Device 2 | Infusion System B | 30 |
| LVP Device 3 | Infusion System B | 30 |
| Optional Control Unit 1 | Infusion System B | 35 |

It should be appreciated that Infusion System A corresponds to medical system 511 and Infusion System B corresponds to medical system 521.

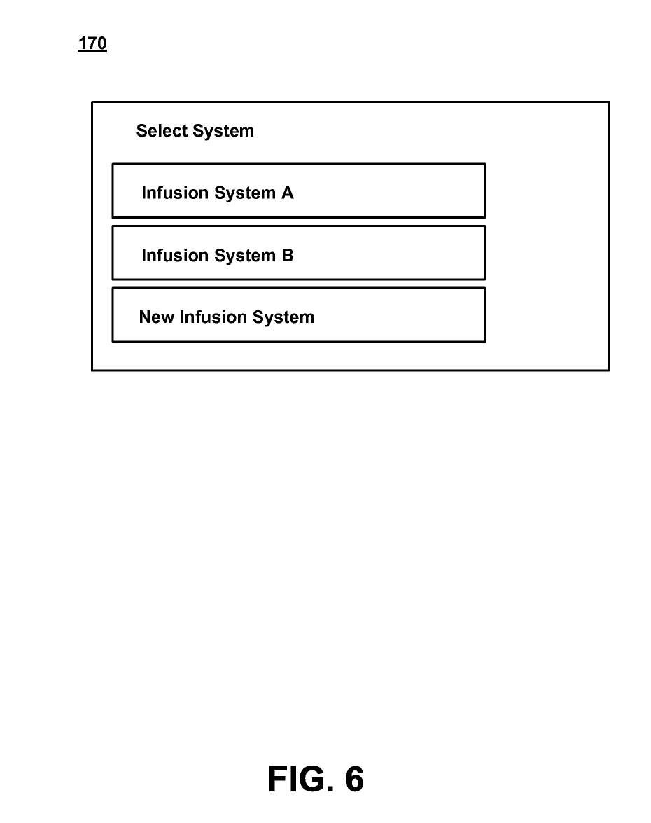

FIG. 6 depicts an embodiment of a list of information displayed to a clinician on display 170. As the list of devices can be based on distance to medical device 110, the clinician is presented with a manageable number of possible infusion systems to which medical device 110 is to be associated.

According to the information described in Table 2, “Infusion System A” is displayed ahead of or before “Infusion System B.” Accordingly, a clinician would select the identifier “Infusion System A,” such that medical device 110 is associated with the identifier for medical system 511.

In response to the selection of “Infusion System A,” identifier associator 160 associates medical device 110 with the identifier for medical system 511. Therefore, medical device 110 is associated with medical system 511.

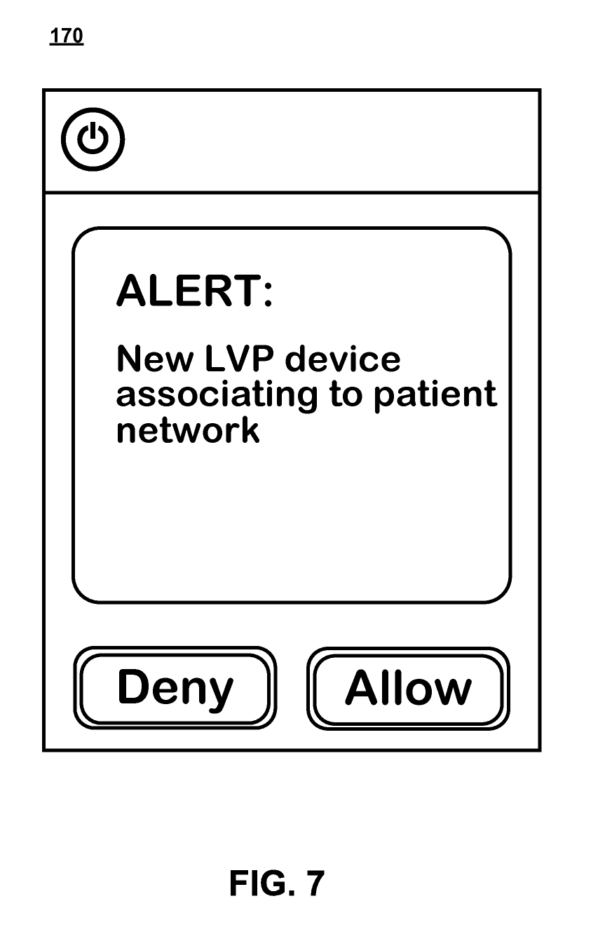

The same discovery methods, as described above, are utilized for medical system (e.g., infusion pumps) that do not have local user interface capabilities for presenting a list of device clusters to a clinician. When a new device enters the cluster, a device with user interface capabilities already in the cluster (e.g., a central programming unit) is utilized to inform the clinician that a new device is ready to be added to the cluster. The clinician would then not be presented with a list of clusters, but instead presented with a screen showing that new device is available to join the cluster, as depicted in FIG. 7.

FIG. 7 depicts an embodiment of information displayed to a clinician. In particular, an alert is provided to a clinician on display 170, in response to a medical device (e.g. an LVP device) becoming available to join a device cluster.

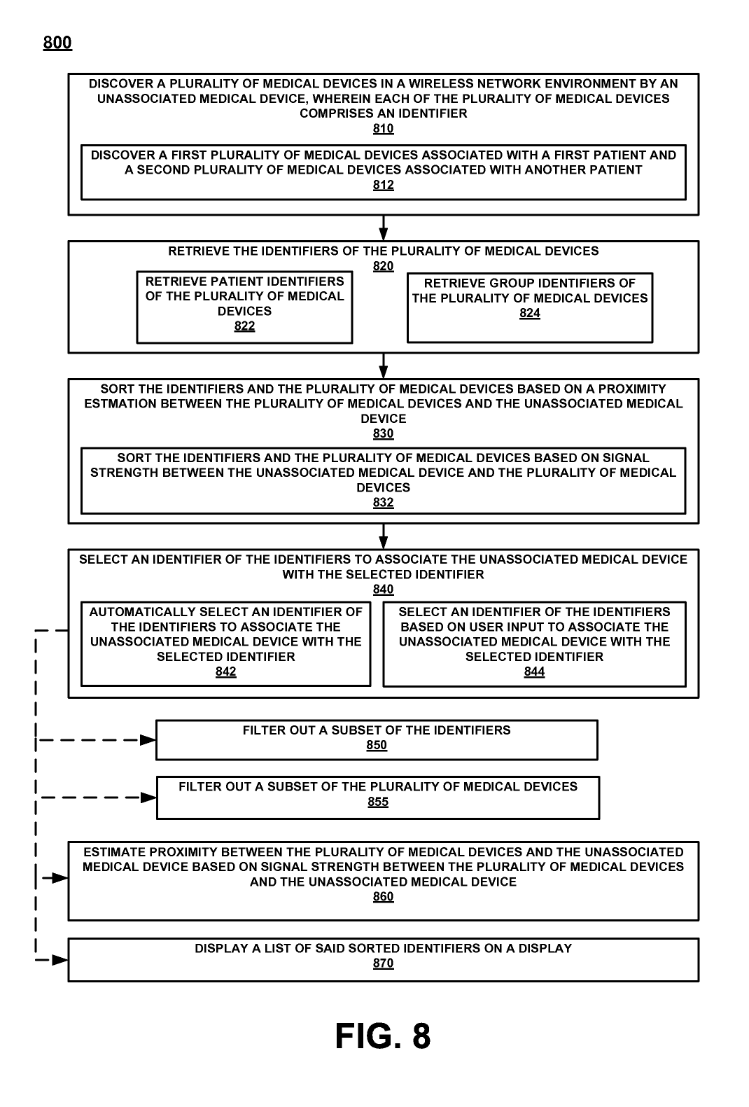

FIG. 8 depicts an embodiment of a method 800 for associating a medical device with an identifier. In various embodiments, method 800 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In some embodiments, method 800 is performed at least by medical device 110, as described in FIG. 1.

At 810, a plurality of medical devices are discovered in a wireless network environment by an unassociated medical device, wherein each of the plurality of medical devices comprises an identifier. For example, medical devices 212-215, 222 and 223 are discovered by medical device 110, wherein the medical devices each comprise a patient identifier.

In one embodiment, at 812, a first plurality of medical devices associated with a first patient and a second plurality of medical devices associated with another patient are discovered. For example, medical devices 212-215 associated with patient 211 are discovered and medical devices 222 and 223 associated with patient 221 are discovered.

At 820, the identifiers of the plurality of medical devices are retrieved. In one embodiment, at 822, patient identifiers of the plurality of medical devices are retrieved. For example, patient identifiers of medical devices 212-215, 222 and 223 are retrieved.

In another embodiment, at 824, group identifiers of the plurality of medical devices are retrieved. For example, group identifiers for medical systems 511 and 521 are retrieved.

At 830, the identifiers and the plurality of medical devices are sorted based on a proximity estimation between the plurality of medical devices and the unassociated medical device. For example, identifiers and/or medical devices are sorted based on proximity between medical devices 411, 411, 421 and medical device 110. The proximity is determined by GPS coordinates of the medical devices.

In one embodiment, at 832, the identifiers and the plurality of medical devices are sorted based on signal strength between the unassociated medical device and the plurality of medical devices. For example, identifiers and/or the medical devices are sorted based on signal strength between medical device 110 and medical devices associated with medical systems 511 and 521.

At 840, an identifier of the identifiers is selected to associate the unassociated medical device with the selected identifier. For example, a clinician selects Patient A (as depicted in FIG. 3). Accordingly, medical device 110 is associated with Patient A.

In one embodiment, at 842, an identifier of the identifiers is automatically selected to associate the unassociated medical device with the selected identifier. For example, if only one patient area network is discovered, then identifier associator 160 automatically associates medical device 110 with the identifier of the patient area network.

In another embodiment, at 844, an identifier of the identifiers is selected based on user input to associate the unassociated medical device with the selected identifier. For example, a clinician selects identifier Infusion System A (as depicted in FIG. 6) on display 170 such that medical device 110 is associated with the identifier.

In one embodiment, at 850, a subset of the identifiers is filtered out. For example, a subset of identifiers filtered out based on characteristics such as care area (e.g., ICU).

In another embodiment, at 855, a subset of the plurality of medical devices is filtered out. For example, a subset or medical devices are filtered out based on characteristics such as device type (e.g., ventilators).

In another embodiment, at 860, proximity between the plurality of medical devices and the unassociated medical device is estimated based on signal strength between the plurality of medical devices and the unassociated medical device.

In a further embodiment, at 870, a list of the sorted identifiers are displayed on a display. For example, sorted identifiers of Patient A and Patient B are displayed on display 170, as depicted in FIG. 3.

Various embodiments of the present invention are thus described. While the present invention has been described in particular embodiments, it should be appreciated that the present invention should not be construed as limited by such embodiments, but rather construed according to the following claims.

1. A method for associating a medical device with an identifier, said method comprising:
discovering a plurality of medical devices in a wireless network environment by an unassociated medical device, wherein each of said plurality of medical devices comprises an identifier;
retrieving said identifiers of said plurality of medical devices;
sorting said identifiers and said plurality of medical devices based on a proximity estimation between said plurality of medical devices and said unassociated medical device; and
selecting an identifier of said identifiers to associate said unassociated medical device with said selected identifier.

2. The method of claim 1, wherein said discovering a plurality of medical devices in a wireless network environment comprises:
discovering a first plurality of medical devices associated with a first patient and a second plurality of medical devices associated with another patient.

3. The method of claim 1, wherein said retrieving said identifiers of said plurality of medical devices comprises:
retrieving patient identifiers of said plurality of medical devices.

4. The method of claim 1, wherein said retrieving said identifiers of said plurality of medical devices comprises:
retrieving group identifiers of said plurality of medical devices.

5. The method of claim 1, further comprising:
estimating proximity between said plurality of medical devices and said unassociated medical device based on signal strength between said plurality of medical devices and said unassociated medical device.

6. The method of claim 1, further comprising:
estimating proximity between said plurality of medical devices based on asset location.

7. The method of claim 1, wherein said sorting said identifiers and said plurality of medical devices comprises:
sorting said identifiers and said plurality of medical devices based on signal strength between said unassociated medical device and said plurality of medical devices.

8. The method of claim 1, further comprising:
filtering out a subset of said identifiers and a subset of said plurality of medical devices.

9. The method of claim 1, further comprising:
filtering out a subset of said plurality of medical devices.

10. The method of claim 1, wherein said selecting an identifier of said identifiers to associate said unassociated medical device with said selected identifier further comprising:
automatically selecting an identifier of said identifiers to associate said unassociated medical device with said selected identifier.

11. The method of claim 1, wherein said selecting an identifier of said identifiers to associate said unassociated medical device with said selected identifier further comprising:
selecting an identifier of said identifiers based on user input to associate said unassociated medical device with said selected identifier.

12. The method of claim 1, further comprising:
displaying a list of said sorted identifiers on a display.

13. A medical device comprising:
a device discoverer for discovering a plurality of medical devices in a wireless network environment, wherein each of said plurality of medical devices comprise an identifier;
an identifier retriever for retrieving said identifiers of said plurality of medical devices;
a sorter for sorting said identifiers and said plurality of medical devices based on proximity between said plurality of medical devices and said medical device, wherein said medical device is unassociated with said identifiers; and
an identifier associator for associating said unassociated medical device with one of said identifiers.

14. The medical device of claim 13, wherein said identifier is selected from a group consisting of: a patient identifier and a group identifier.

15. The medical device of claim 13, further comprising:
a proximity estimator for estimating a proximity between said unassociated medical device and said plurality of medical devices.

16. The medical device of claim 13, further comprising:
a filter for filtering a subset of information selected from a group consisting of: said identifiers and said medical devices.

17. The medical device of claim 13, further comprising:
an identifier associator for associating said unassociated medical device with a selected identifier.

18. The medical device of claim 13, further comprising:
a display for displaying said sorted identifiers.
